(19) United States
(12) Patent Application Publication
(10) Pub. No.: US 2007/0024636 A1
(43) Pub. Date: Feb. 1, 2007

(54) Apparatus and method for color dithering

(76) Inventor: Jui-Lin Lo, Yongkang City (TW)

Correspondence Address: J.C. Patents, Inc., Suite 250, 4 Venture, Irvine, CA, 92618, US

(21) Appl. No.: 11/326,748

(22) Filed: Jan. 5, 2006

(30) Foreign Application Priority Data
Aug. 1, 2005 (TW) 94126012

(51) Int. Cl. G09G 5/02

(52) U.S. Cl. 345/596

(57) ABSTRACT

An apparatus and the method which implement color dithering having an extended period for preventing perceivable dithering noise caused by the asymmetry and un-ideal characteristics existing in a display system are provided. The apparatus includes a separator, a carry generator, an adder and a limiter. The separator receives a color value and separates the color value into a high-bit color value and a low-bit color value. Then the carry generator provides a carry value to be either one or zero, according to a random number from a random number generator and the low-bit color value. The adder adds the high-bit color value and the carry value, and provides the result as a tentative output value. Finally, the limiter receives the tentative output value and outputs the smaller value of the tentative output value and a pre-set upper limit.

### CROSS-REFERENCE TO RELATED APPLICATION

This application claims the priority benefit of Taiwan application serial no. 94126012, filed on Aug. 1, 2005. All disclosure of the Taiwan application is incorporated herein by reference.

### BACKGROUND OF THE INVENTION

1. Field of Invention

The present invention relates to an apparatus and method for color dithering. More particularly, the present invention relates to a color dithering apparatus and method thereof which determines whether to carry to the higher digit based on a random number.

2. Description of Related Art

Today, visual signal sources generated from integrated circuits, and software of computers and videos are capable to produce more and more color levels, for example, 256 color levels with 8-bit resolution or 1024 color levels with 10-bit resolution. However, conventional visual output apparatuses such as displays, projectors, printers, etc, are limited in the exhibition of color depth at for example only 64 color levels due to the consideration of hardware cost. For displaying the original vivid color, the color dithering technology is used for enhancing the color depth in a reduced color display system.

The conventional color dithering technology is as shown in FIG. 1. FIG. 1 is a block diagram illustrating a conventional color dithering apparatus 100. The color dithering apparatus 100 includes a separator 101, a carry generator 102, an adder 103, and a limiter 104. Assuming that the resolution of the signal source is M bits, the resolution of the output apparatus is at M−N bits, in which M and N are both positive whole numbers, and M>N>=1. First, the separator 101 receives a M-bit color value A1[M−1:0] and separates the color value A1[M−1:0] into N least significant bits (referred to as LSB thereafter) A1[N−1:0] and M−N most significant bits (referred to as MSB thereafter) A1[M−1:N].

After the separation, the carry generator 102 will look up in the table according to the aforementioned LSB A1[N−1:0] and some other factors such as the location of the pixel or the frame counter's value for example to determine whether to carry. The carry value 111 shall be equal to 1 if carries; otherwise the carry value 111 shall be equal to 0. The adder 103 will add the aforementioned MSB A1[M:N] and carry value 111, and then outputs the summation result A2[M:N]. Finally, the limiter 104 is used for restricting the value of A2[M:N] so that it does not exceed the upper limit of the visual output apparatus, the restricted result A3[M−1:N] shall be provided to the visual output apparatus for display.

The table look-up method of the conventional color dithering technology can be classified into the static and dynamic methods. The so-called static method refers to the same table in every frame. The table used in static dithering methods is designed to make the spatial average of the dithered neighbor pixels is equal to the value of the un-dithered original value. While applying the dynamic method, different tables are used in successive input frames. The different tables used in the dynamic dithering method are designed to make the temporal average as well as the spatial average of a dithered pixels are equal to the value of the un-dithered original value. In fact the dynamic and static dithering can be combined to a mixed method to make the spatial and temporal averages equal to the un-dithered color values. However, no matter whether it is static dithering or dynamic dithering, due to the limit in the complexity and the cost of the circuitry or the dithering algorithm, the conventional dithering methods' spatial and temporal periods are usually quite limited. The short period in time and space are easily tracked and predicted by human perception thus results in deteriorated performance.

Besides, sometimes the input signal has its own spatial period such as dot Moire and line Moire video test pattern, and also in some systems, as an example, in liquid crystal displays (LCD), the properties of each pixel are not necessary identical due to some electrical characteristics variation in production, which will cause some undesired periodic variation in time and space. Moreover, the inversion method (dot line and frame inversion) used in LCD driver will often leads to some degree of asymmetry, therefore results in periodical fluctuation in space and time. Once the aforementioned system periodical fluctuation interacts with the periodical variation due to dithering, the dithering noise will becomes more visually perceivable and leads to flickering, thus may degrade image quality. It will be quite unacceptable for human eyes.

### SUMMARY OF THE INVENTION

Accordingly, the objective of the present invention is for providing an apparatus and method thereof for color dithering, which efficiently implements color dithering having extended period for preventing perceivable dithering noise, or for reducing the interaction with the circuit or system characteristics variation which will decreases image quality.

To achieve the aforementioned goal in the present invention, an apparatus for color dithering is provided, which includes a separator, a carry generator, an adder, and a limiter. First, the separator receives a M-bit color value and separates the color value into a high-bit color value and a low-bit color value. In which, the low-bit color value includes the N LSB of the color value, and the high-bit color value includes the M−N MSB of the color value. M and N are both positive integers determined according to the system configuration and cost consideration, and M>N>=1. Next, the random number generator in the carry generator produces a random number. The carry generator provides a carry value according to the random number value and the low-bit color value. The adder provides a tentative output value which is the summation of the high-bit color value and the carry value. Finally, the limiter receives the tentative output value and outputs the smaller number among the tentative output value and a pre-set upper limit.

In an embodiment of the aforementioned color dithering apparatus, the above mentioned carry generator further includes a random number generator and an arbiter. In which, the random number generator generates N bits of random number value. The arbiter adds the aforementioned low-bit color value and the aforementioned random number. If the sum produces a carry (i.e.: the summation is bigger than 2ˆN), 1 will be the carry generator output (to carry to the MSB); otherwise, 0 will 1 be outputted (to discard the low-bit color value).

In another embodiment of the aforementioned color dithering apparatus, the above mentioned carry generator further includes a table look-up carry generator, a random carry generator, and a selector. The table look-up carry generator provides a table look-up carry value according to the low-bit color value and location of pixel in a frame and/or the value frame counter using the table look-up method. The random carry generator provides a random carry value according to the summation of an N-bit random number value and the low-bit color value. Finally, the selector chooses among the table look-up carry value and the random carry value as the final carry value according to some pre-defined sequence or selection circuit or algorithm.

In an embodiment of the mentioned color dithering apparatus, the aforementioned random carry generator further includes a random number generator and an arbiter. The random number generator generates a plurality of random number values. The arbiter adds the low-bit color value to the random number value, and outputs 1 as the random number carry value if the summation produces a carry; otherwise, it outputs 0 as the random number carry value. The timing and method to update the random number value can be designed according to different algorithms.

In the present invention, another method for color dithering is provided, which includes the following: first, a M-bit color value is received, and the color value is separated into high-bit color value and low-bit color value. In which, the low-bit color value includes N LSB of the color value, whereas the high-bit color value includes M−N bits MSB of the color value. M and N are both positive integers and M>N>=1. Next, a carry value is provided according to a random number and the low-bit color value, and a tentative output value, which is the summation of the high-bit color value and the carry value, is provided. Finally, the smaller one among the tentative output value and a pre-set upper limit is outputted as the dithering result.

According to the present invention, whether to carry is determined according to a random number. The random number generator can de achieved with low cost while keeping the long period. Thus the present invention is able to prevent perceivable color dithering noise and the annoying fluctuation caused by regular input video signal or undesired interaction with system configuration and circuitry. Moreover, the present invention is can be easily integrated with the conventional table look-up method to gain the advantages.

To make the aforementioned and other objects, features, and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a conventional color dithering apparatus.

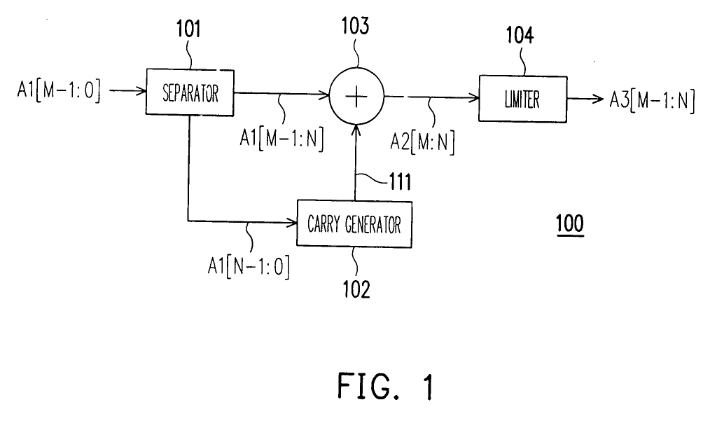

FIG. 2 is a block diagram illustrating a color dithering apparatus, according to an embodiment of the present invention.

FIG. 3 is a block diagram illustrating a color dithering apparatus, according to another embodiment of the present invention.

### DESCRIPTION OF EMBODIMENTS

In the following description, it is assumed that the color resolution of the signal source is M bits, and the color resolution of the output apparatus is M−N bits. M and N are both positive integers, and M>N>=1.

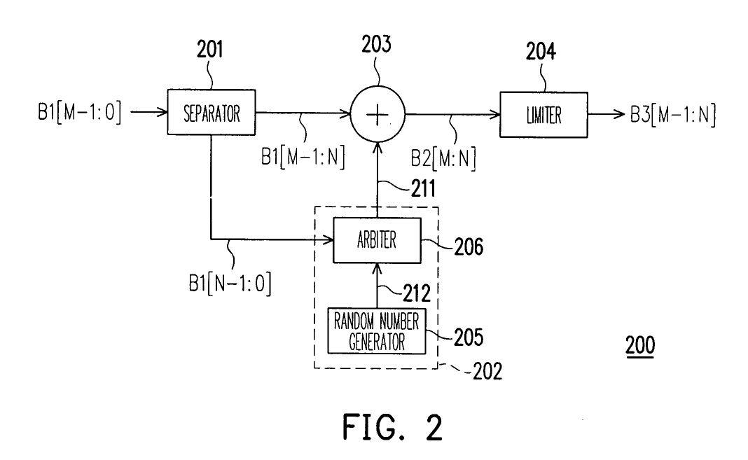

An embodiment of the present invention is described in FIG. 2, which is a block diagram illustrating the color dithering apparatus 200, according to the present embodiment of the present invention. The color dithering apparatus 200 includes a separator 201, a carry generator 202, an adder 203, and a limiter 204. First, the separator 201 receives a M-bit color value B1[M−1:0] and separates the color value B1[M−1:0] into a high-bit color value B1[M−1:N] and a low-bit color value B1[N−1:0]. In which, the low-bit color value B1[N−1:0] includes N LSBs of color value B1[M−1:0] and the high-bit color value B1[M−1:N] includes M−N MSBs of color value B1[M−1:0].

Next, the carry generator 202 provides a carry value 211 according to a random number and the low-bit color value B1[N−1:0]. In the present embodiment, the carry generator 202 includes a random number generator 205 and an arbiter 206. The random number generator 205 is responsible for generating a N-bit random number value 212. Then the arbiter 206 shall add the random number value 212 and the low-bit color value B1[N−1:0]. If the summation produces a carry; that is, the sum is greater than or equal to 2^{N}, the arbiter 206 will output 1 as the carry value 211; otherwise, the arbiter 206 will output 0 as the carry value 211. Since many different methods in conventional technologies can be applied for the circuitry and algorithm for generating the random number, they will not be described herein.

After the carry value 211 is generated, the adder 203 adds the carry value 211 to the high-bit color value B1[M−1:N] and outputs the result as a tentative output value B2[M:N]. Then the limiter 204 receives the tentative output value B2[M:N] and outputs the smaller value among the tentative output value B2[M:N] and a pre-set upper limit in the display system so that the final output value B3[M−1:N] will not exceed the allowable upper limit of the output apparatus. For example, in the present embodiment, the pre-set upper limit is 2^{M-N}−1, even their sum is equal to 2^{M-N}, the limiter 204 shall only output 2^{M-N}−1.

One of the advantages of the present embodiment is that the random number generator 205 is able to use simple circuit at lower cost for efficiently providing random number with extended long period. For example, by using the linear shift feedback register (LSFR) using X stages registers, the longest period of the random number can be achieved is 2^{X}−1 if a appropriate feedback connection between the registers is used. Because the period of the random number will be quite long, the dithering noise will not be easily perceivable to the users; therefore, the dithering display quality will be improved. In addition, since the least common multiple of 2^{X}−1 and the total number of pixels in a frame are quite large, the spatial period of the output of the random number generator shall be very huge. Therefore, it will be much unlikely to interact with the driving method, for example, line inversion or frame inversion, etc. In the application of liquid crystal displays, the dithering noise which decreases image quality can be relieved or at least it will be less perceivable. Table 1 below is an example which indicates that the carry generator 202 is able to use a simple adder for adding low-bit color value and random number value for producing a proper carry output. Table 1. The sum of the low-bit color value and the random number value can be used to produce the carry value.

TABLE 1

low-bit color
value

| | | 0 | 1 | 2 | 3 |
|---|---|---|---|---|---|
| random | 0 | 0 | 1 | 2 | 3 |
| number | 1 | 1 | 2 | 3 | 4 |
| value | 2 | 2 | 3 | 4 | 5 |
| | 3 | 3 | 4 | 5 | 6 |

| | | | | |
|---|---|---|---|---|
| carry | 0 | ¼ | 2/4 | ¾ |
| probability | | | | |

Let N equal to 2 as an example, each column of table 1 represents a low-bit color value B1[N−1:0], which falls in the range from 0 to 3, and each row represents the random number value 212, which falls between 0 and 3 If the sum is greater than or equal to 4, the carry value 211 is 1; otherwise, the carry value 211 is 0. According to table 1, it is obvious that if the low-bit color value is 0, the carry will never be one. If the low-bit color value is 1, the probability of carry is ¼. If the low-bit color value is 2, the probability of carry is 2/4. If the low-bit color value is 3, the probability of carry is ¾. Accordingly, as long as the probability of every random number value is the same, the color dithering technology in the present invention has the same probability of carry as the conventional technology, which is the carry probability of any low-bit color value B1[N−1:0] is B1[N−1:0]/2^{N}. This is exactly what we want to get in dithering technology.

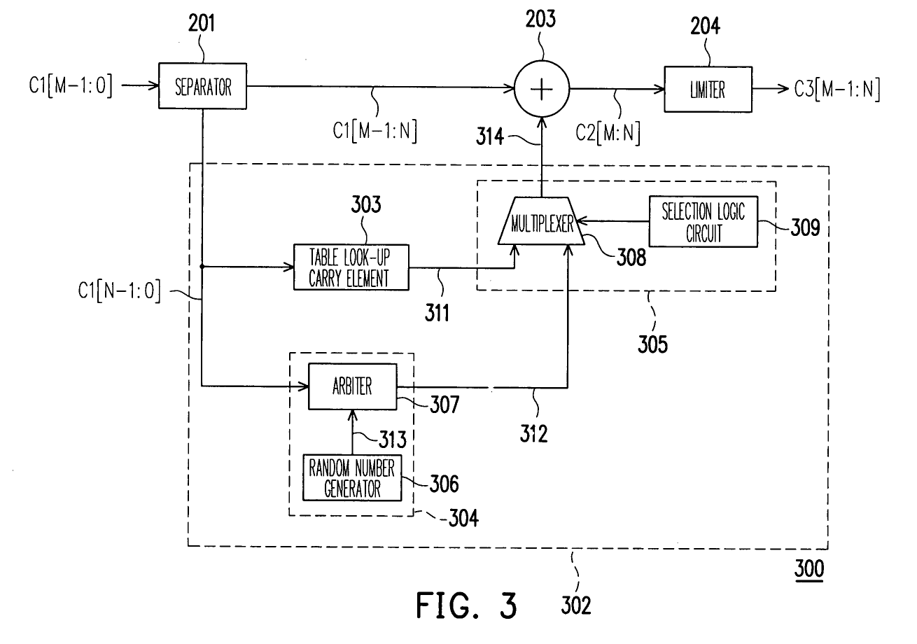

It is also possible and easy to combine the random number carry method and the conventional table look-up carry method to the gain both the fine graininess in the table look-up dither method and the unpredictability of the random dither method. FIG. 3 is used for illustrating such an embodiment.

Referring to FIG. 3, it is a block diagram illustrating the color dithering apparatus 300, which shows an another embodiment of the present invention. The color dithering apparatus 300 has the same separator 201, adder 203, and limiter 204 as the color dithering apparatus 200 in FIG. 2. First, the separator 201 shall separate the input color values C1[M−1:0] into high-bit color values C1[M−1:N] and low-bit color values C1[N−1:0], then the low-bit color value C1[N−1:0] shall be received by the carry generator 302.

The carry generator 302 includes a table look-up carry generator 303, a random number carry generator 304, and a carry selector 305. The table look-up carry generator 303 shall provide a table look-up carry value 311 according to the low-bit color value C1[N−1:0] and location of pixel in a frame and/or the value frame counter as in the conventional table look-up method. Here the method of table look-up can be static or dynamic, and the table look-up carry value 311 is 0 or 1. The functionality of the random number carry generator 304 is the same as the functionality of the carry generator 202 in FIG. 2. In which, the random number generator 306 shall generate a N-bit random number value 313, then the arbiter 307 shall add the low-bit color value C1[N−1:0] to the random carry value 313. If the summation produces a carry to the MSB bits, the arbiter 307 shall output 1 as the random carry value 312; otherwise it shall output 0 as the random number carry value 312.

The carry selector 305 includes a multiplexer 308 and a selection logic circuit 309. In which, the selection logic circuit 309 provides a method of selection which allows the multiplexer 308 to select an output from the table look-up carry value 311 and the random carry value 312 as the final carry value 314. Thus, the random number carry method and the conventional table look-up method can be combined for incorporating their advantages. The method of selection between the two carry values can be determined according to the actual requirements of the application. For example, it may select the table look-up carry value 311 among the first 3 frames within every 4 successive frames, and select the random carry value 312 in the last frame (the fourth frame), or on the contrary, inverse the selection process of the final carry value, or the using of more complicated algorithm in selections.

The present invention also provides a color dithering method besides the color dithering apparatus described within the above embodiments. In instead of the hardware, some or all parts of the dithering circuitry can be replaced by their software counterparts. The above embodiments are sufficient for explaining the color dithering method of the present invention.

In summary, the decision of whether to carry or not in color dithering is made according to the random number produced by the random number generator. An extended long period can be easily obtained at low cost by simple technology such as LFSR. Thus the present invention is quite effective in preventing the perceivable dithering noise and the interactions with the undesired periods of system circuits or signals, which will deteriorate the image quality. Moreover, in the present invention, we can easily combine the conventional table look-up method with the random method to gain their both advantages.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for color dithering, comprising:
a separator which receives a M-bit color value and separates the color value into a high-bit color value and a low-bit color value, wherein the low-bit color value comprises N LSB of the color value, and the remaining high-bit color value comprises M−N MSB of the color value, M and N are both positive integers and M>N>=1;
a carry generator which provides a carry value according to a random number and the low-bit color value;
an adder which provides a tentative output value, the tentative output value is the sum of the high-bit color value and the carry value; and
a limiter which receives the tentative output value and outputs the smaller value among the tentative output value and a pre-set upper limit.

2. The color dithering apparatus in claim 1, wherein the carry value is either 0 or 1, 0 represents no carry and 1 represents carry to the high color value (MSB).

3. The color dithering apparatus in claim 1, wherein the carry generator further includes:
a random number generator which generates a random number; and
an arbiter which provides a carry value according to the certain mathematical operation result of the random number value and the low-bit color value.

4. The color dithering apparatus in claim 3, wherein the arbiter extracts N bits from the random number value for the calculation.

5. The color dithering apparatus in claim 3, the carry generator output 1 means a carry, and 0 means no carry to the high color value according to the result of the mathematical operation in the arbiter.

6. The color dithering apparatus in claim 5, wherein the calculation method of the arbiter is the summation of the random number value and the low-bit color value.

7. The color dithering apparatus in claim 3, wherein the carry probability to the high color value is equal to the low-bit color value divided by 2^{N}.

8. The color dithering apparatus in claim 3, wherein the random number generator consists of a linear shift feedback register (LSFR).

9. The color dithering apparatus in claim 3, wherein the distribution of the random numbers generated by the random number generator is very close to the uniform distribution.

10. The color dithering apparatus in claim 1, wherein the carry generator further includes:
a table look-up carry generator which provides a table look-up carry value in the table look-up method according to the low-bit color value and the horizontal and/or vertical position in the frame and/or the frame counter value which increases by one when a new frame is received;
a random carry generator which provides a random carry value according to the generated random number and the low-bit color value; and
a selector which outputs one of the table look-up carry value and the random carry value as the final carry value according to a pre-designed method of selection.

11. The color dithering apparatus in claim 7, wherein the random carry element further includes:
a random number generator which generates the random number value; and
an arbiter which, according to a pre-defined calculation method, outputs 1 to indicates carry to the high color value and 0 indicate no carry.

12. The color dithering apparatus in claim 10, wherein the random number value is N-bit, or N-bit extracted from a random number with more bits.

13. The color dithering apparatus in claim 12, wherein the probability of occurrence of the random number is very close to equal (uniform distribution) from 0 to 2^{N}−1.

14. The color dithering apparatus in claim 10, wherein the random number generator consists of a linear shift feedback register.

15. A method for color dithering, comprising the following steps:
(a) receiving a M-bit color value and separating the M-bit color value into a high-bit color value and a low-bit color value, wherein the low-bit color value comprises N LSB of the color value, the remaining high-bit color value comprises M−N MSB of the color value, M and N are both pre-set positive integers and M>N>=1;
(b) providing a carry value according to the random number and the low-bit color value;
(c) providing the sum of the high-bit color value and the carry value as a tentative output value; and
(d) outputting the smaller value of the tentative output value and a pre-set upper limit.

16. The color dithering method in claim 15, wherein the carry value is either 0 or 1. When carry value is “1”, there is a carry to the high color value.

17. The color dithering method in claim 15, wherein step (b) of claim 15 further includes:
(b1) generating a random number; and
(b2) producing the carry value according to the random-number value and the low-bit color value.

18. The color dithering method in claim 17, wherein the random number value is N-bit, or N-bit extracted from a random number with more bits.

19. The color dithering method in claim 17, wherein step (b2) further includes:
outputting 1 as the carry value according to the calculation result to indicate carry to the high color value.

20. The color dithering method in claim 19, wherein the calculation method is to add the random number value and the low-bit color value.

21. The color dithering method in claim 15, wherein step (b) further includes:
(b1) providing a table look-up carry value in the table look-up method according to the low-bit color value and the horizontal and/or vertical position of a pixel and/or the frame counter value which increase by one when a new frame is received;
(b2) providing a random number carry value according to the calculation result of a random number value and the low-bit color value; and
(b3) outputting one of the table look-up carry value and the random carry value as the carry value according to a pre-designed method of selection.

22. The color dithering method in claim 20, wherein the step (b2) further includes:
outputting 1 as the random carry value to carry if the calculation result of the random number value and the low-bit color value results in carry, otherwise outputting 0 as the random carry value.

23. The color dithering method in claim 22, wherein the calculation method is to add the random number value and the low-bit color value.

24. The color dithering method in claim 22, wherein the random number value is N-bit, or N-bit extracted from a random number with more bits.

25. The color dithering method as claimed in claim 24, wherein the probability of occurrence of every the random numbers as the random number is very close to equal (uniform distribution) from 0 to 2^{N}−1.
